(19) United States
(12) Patent Application Publication
(10) Pub. No.: US 2023/0134372 A1
(43) Pub. Date: May 4, 2023

(54) CHARACTERIZATION OF SUBSURFACE FEATURES USING IMAGE LOGS

(71) Applicant: Chevron U.S.A. Inc., San Ramon, CA (US)

(72) Inventors: Mason C. Edwards, Houston, TX (US); Evan James Earnest-Heckler, Spring, TX (US); Stephen D. Yow, Houston, TX (US); Min Li, Sugarland, TX (US)

(21) Appl. No.: 17/514,937

(22) Filed: Oct. 29, 2021

(51) Int. Cl. G06K 9/46; G06T 7/10; G06T 7/70

(52) U.S. Cl. CPC G06K 9/46; G06T 7/10; G06T 7/70; G06T 2207/20084; G06T 2207/30161

(57) ABSTRACT

An image log of a subsurface region may be divided into multiple image log segments. The multiple image log segments may be processed through a computer vision neural network to identify both (1) the types of subsurface features within the subsurface region, and (2) the locations of the subsurface features within the subsurface region.

### FIELD

The present disclosure relates generally to the field of characterizing subsurface regions using image logs.

### BACKGROUND

Downhole image logs may include information on subsurface features within a subsurface region. Identification of these subsurface features from image logs may be performed manually by an interpreter or may use existing image processing techniques that may require manual quality checks and adjustment of image processing parameters, which may be difficult, time-consuming, and inject subjectivity into the analysis. Existing tools for identifying subsurface features may be unreliable and may not classify the identified subsurface features.

### SUMMARY

This disclosure relates to characterizing subsurface regions. Image log information and/or other information may be obtained. The image log information may define one or more image logs of a subsurface region. The image log(s) may be divided into multiple image log segments. The subsurface region may be characterized based on analysis of the multiple image log segments and/or other information. Characterization of the subsurface region may include identification of one or more subsurface features within the subsurface region, determination of probability of the subsurface feature(s) identified within the subsurface region, determination of location of the subsurface feature(s) identified within the subsurface region, and/or other characterization of the subsurface region.

A system for characterizing subsurface regions may include one or more electronic storage, one or more processors and/or other components. The electronic storage may store image log information, information relating to image logs, information relating to division of image logs, information relating to multiple image log segments, information relating to characterization of subsurface region, information relating to subsurface features, information relating to probability of subsurface features, information relating to location of subsurface features, and/or other information.

The processor(s) may be configured by machine-readable instructions. Executing the machine-readable instructions may cause the processor(s) to facilitate characterizing subsurface regions. The machine-readable instructions may include one or more computer program components. The computer program components may include one or more of an image log component, a preparation component, an analysis component, and/or other computer program components.

The image log component may be configured to obtain image log information and/or other information. The image log information may define one or more image logs of a subsurface region.

The preparation component may be configured to divide the image log(s) into multiple image log segments. In some implementations, an image log may be divided into the multiple image log segments such that adjacent image log segments have an overlapping area. In some implementations, an image log may be divided into the multiple image log segments such that adjacent image log segments do not have an overlapping area. In some implementations, an image log may include one or more gaps, and the gap(s) may be removed from the image log before the division of the image log into the multiple image log segments.

The analysis component may be configured to characterize the subsurface region. The subsurface region may be characterized based on analysis of the multiple image log segments and/or other information. Characterization of the subsurface region may include identification of one or more subsurface features within the subsurface region, determination of probability of the subsurface feature(s) identified within the subsurface region, determination of location of the subsurface feature(s) identified within the subsurface region, and/or other characterization of the subsurface region.

In some implementations, the analysis of the multiple image log segments for the characterization of the subsurface region may include: (1) processing the multiple image log segments through a base neural network, the base neural network providing feature maps for the multiple image log segments; and (2) processing the feature maps for the multiple image log segments through a region proposal network.

The region proposal network may perform one or more classification tasks, one or more regression tasks, and/or other tasks. A classification task may include the identification of the subsurface feature(s) within the subsurface region and the determination of the probability of the one or more subsurface features identified within the subsurface region. A regression task may include the determination of the location of the subsurface feature(s) identified within the subsurface region.

In some implementations, the subsurface feature(s) identified within the subsurface region may include one or more sinusoidal subsurface features. In some implementations, the characterization of the subsurface region may further include identification of dip and azimuth of the sinusoidal subsurface feature(s).

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for characterizing subsurface regions.

FIG. 2 illustrates an example method for characterizing subsurface regions.

FIG. 3 illustrates an example image log.

FIGS. 4A and 4B illustrate example division of the image log shown in FIG. 3.

FIG. 5 illustrates example identification of sinusoidal features within an image log.

### DETAILED DESCRIPTION

The present disclosure relates to characterizing subsurface regions. An image log of a subsurface region may be divided into multiple image log segments. The multiple image log segments may be processed through a computer vision neural network to identify both (1) the types of subsurface features within the subsurface region, and (2) the locations of the subsurface features within the subsurface region.

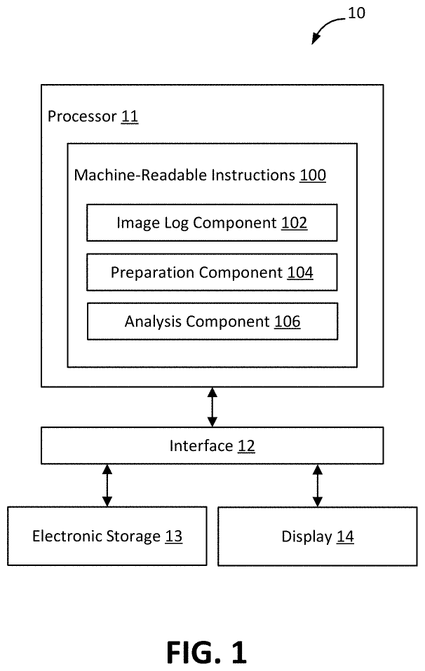

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Image log information and/or other information may be obtained by the processor 11. The image log information may define one or more image logs of a subsurface region. The image log(s) may be divided into multiple image log segments by the processor 11. The subsurface region may be characterized by the processor 11 based on analysis of the multiple image log segments and/or other information. Characterization of the subsurface region may include identification of one or more subsurface features within the subsurface region, determination of probability of the subsurface feature(s) identified within the subsurface region, determination of location of the subsurface feature(s) identified within the subsurface region, and/or other characterization of the subsurface region.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store image log information, information relating to image logs, information relating to division of image logs, information relating to multiple image log segments, information relating to characterization of subsurface region, information relating to subsurface features, information relating to probability of subsurface features, information relating to location of subsurface features, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present image log information, information relating to image logs, information relating to division of image logs, information relating to multiple image log segments, information relating to characterization of subsurface region, information relating to subsurface features, information relating to probability of subsurface features, information relating to location of subsurface features, and/or other information.

Existing methods for identification and classification of subsurface features (e.g., sinusoidal geological features, such as stratigraphic structures and natural fractures) in image logs may rely on use of contrasts in measurement of the host rock (e.g., resistivity, conductivity, acoustic, etc.). Such methods may not be capable of classifying sinusoids of different types of subsurface features (e.g., stratigraphic bedding vs. natural fractures, classes of fractures, etc.). Existing methods for identification and classification of subsurface features may be time consuming and require user-tuning of various parameters, which may inject subjectivity into the analysis/interpretation. For example, such methods may require application of mathematics (e.g., calculation of gradient in images) to parameterize and test different configuration to fit a sinusoid to an image. Such methods are time consuming and not scalable or transferable.

The present disclosure provides a tool that utilizes computer vision neural networks (e.g., Convolutional-Neural-Network, Faster Region-Based Convolutional-Neural-Network, YOLO, etc.) to identify and classify subsurface features, such as sinusoidal features associated with natural fractures and stratigraphic structures, in downhole image logs from a wide range of reservoir types and image log types. The neural network is trained to identify specific types of subsurface features independently of the asset type in which the subsurface features are located. The current tool provides interpretation of the subsurface region using image logs to identify the presence of subsurface features in a subsurface region, identify the class/type of the subsurface feature, and determine the geometry (e.g., shape, location) of the subsurface feature in the subsurface region.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate characterizing subsurface regions. The machine-readable instructions 100 may include one or more computer program components. The machine-readable instructions 100 may include an image log component 102, a preparation component 104, an analysis component 106, and/or other computer program components.

The image log component 102 may be configured to obtain image log information and/or other information. Obtaining image log information may include one or more of accessing, acquiring, analyzing, determining, examining, identifying, loading, locating, opening, receiving, retrieving, reviewing, selecting, storing, and/or otherwise obtaining the image log information. The image log component 102 may obtain image log information from one or more locations. For example, the image log component 102 may obtain image log information from a storage location, such as the electronic storage 13, electronic storage of a device accessible via a network, and/or other locations. The image log component 102 may obtain image log information from one or more hardware components (e.g., a computing device) and/or one or more software components (e.g., software running on a computing device). In some implementations, the image log information may be obtained from one or more users. For example, a user may interact with a computing device to input the image log information (e.g., upload the image log information, identify which image log will be used).

The image log information may define one or more image logs of a subsurface region. A subsurface region may refer to a part of earth located beneath the surface/located underground. A subsurface region may refer to a part of earth that is not exposed at the surface of the ground. A subsurface region may include a reservoir. A reservoir may refer to a location at which one or more resources are stored. For example, a reservoir may refer to a location at which hydrocarbon are stored. For instance, a reservoir may refer to a location including rocks in which oil and/or natural gas have accumulated. A subsurface region may include one or more subsurface features. A subsurface feature may refer to a distinctive attribute, aspect, and/or element within the subsurface region. A subsurface feature may relate to/be defined by geometry and/or composition of materials within the subsurface region.

An image log of a subsurface region may refer to an image that presents characteristics of the subsurface region in a visual form. An image log may refer to a result of taking measurements of the subsurface region and converting the measurements into a visual representation. The image log information may define one or more types of image logs. For example, the image log(s) defined by the image log information may include ultrasonic type of image log(s), electrical resistivity type of image log(s), and/or other types of image logs.

The image log information may define an image log by including information that defines one or more content, qualities, attributes, features, and/or other aspects of the image log. For example, the image log information may define an image log by including information that makes up the content of the image log, and/or information that is used to determine the content of the image log. For instance, the image log information may include information that makes up and/or is used to determine the arrangement of pixels, characteristics of pixels, values of pixels, and/or other aspects of pixels that define the content of the image log. For example, the image log information may include information that makes up and/or is used to determine pixels of the image log. Other types of image log information are contemplated.

The preparation component 104 may be configured to divide the image log(s) into multiple image log segments. Dividing an image log into multiple image log segments may include separating the image log into multiple image log segments. An image log may be divided into multiple image log segments so that individual image log segments include parts of the image log. An image log may be divided into multiple image log segments so that different image log segments include different parts of the image log. The multiple image log segments may be divided into separate image files or as different parts of an image file.

In some implementations, an image log may be divided into multiple image log segments such that adjacent image log segments have an overlapping area. That is, two adjacent image log segments may include the same part of the image log. In some implementations, an image log may be divided into multiple image log segments such that adjacent image log segments do not have an overlapping area. That is, two adjacent image log segments may not include the same part of the image log.

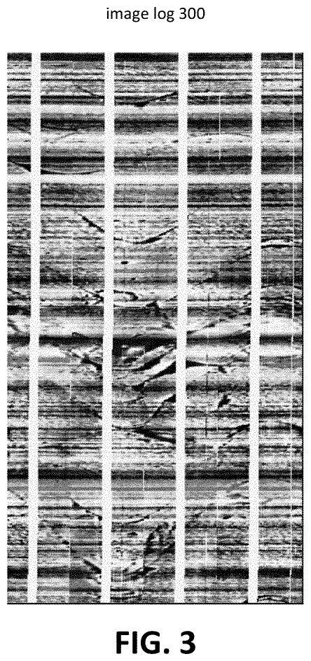

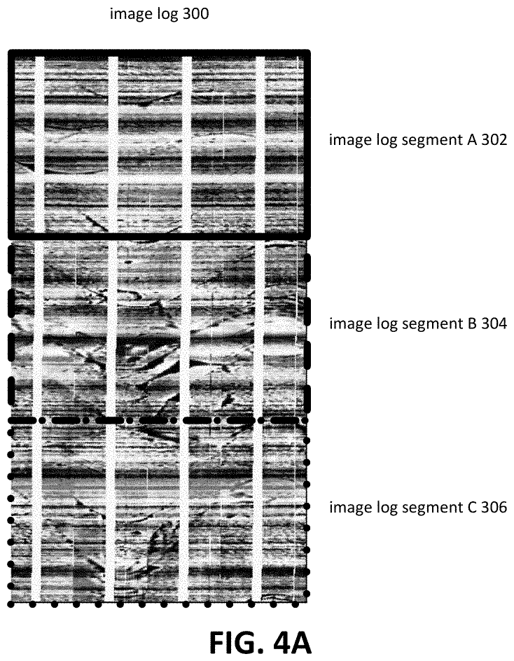

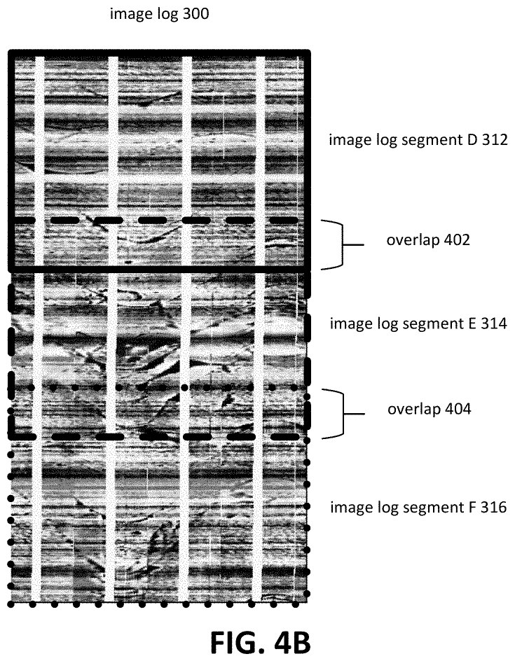

For example, FIG. 3 illustrates an example image log 300. The image log 300 may be divided into multiple image log segments, such as shown in FIGS. 4A and 4B. As shown in FIG. 4A, the image log 300 may be divided into an image log segment A 302, an image log segment B 304, and an image log segment C 306. The image log segments 302, 304, 306 may not have any overlap. As shown in FIG. 4B, the image log 300 may be divided into an image log segment D 312, an image log segment E 314, and an image log segment F 316. The bottom portion of the image log segment D 312 may overlap with the top portion of the image log segment E 314, and the bottom portion of the image log segment E 314 may overlap with the top portion of the image log segment F 316. The size of the overlap 402 between the image log segment D 312 and the image log segment E 314 may be the same or different from the size of the overlap 404 between the image log segment E 314 and the image log segment F 316. While the image log is shown as being divided vertically in FIGS. 4A and 4B, this is merely as an example and is not meant to be limit. In some implementations, the image log may be divided vertically, laterally, or vertically and laterally.

In some implementations, the multiple image log segments may be divided from the image log to having overlaps to increase the likelihood that a subsurface feature is fully included within an image log segment. Dividing the image log into multiple image segments that do not have any overlap may increase the possibility that a subsurface feature is separated into multiple image log segments (e.g., a subsurface feature chopped into two different image log segments). The size of the overlap between the image log segments may be controlled/adjusted based on the size of the subsurface feature to be analyzed. The size of the overlap between the image log segments may be controlled/adjusted so that the subsurface feature has an opportunity to be fully included within an image log segment.

An image log may include one or more gaps. For example, referring to FIG. 3, the image log 300 may include four vertical gaps (three seams running vertically across the image log 300). The gap(s) in the image log may represent subsurface location in which insufficient data (e.g., measurements) exists (e.g., no measurements are collected, insufficient measurements are obtained). In some implementations, the gap(s) may be removed from the image log. For example, the gap(s) in the image log may be removed before the division of the image log into multiple image log segments. Removing the gap(s) from the image log may enable the image log to be analyzed for portions in which sufficient data exists. In some implementations, the gap(s) may not be removed from the image log. For example, the gap(s) in the image log may not be removed before the division of the image log into multiple image log segments. Retaining the gap(s) in the image log may enable analysis of the image log to account for gaps in data.

An image log may have dimensions that are different from dimensions of regular/traditional images. Dimensions of an image may refer to size, length, and/or height of the image. Regular/traditional images may refer to images captured in regular/traditional photography, such as in portrait and/or landscape photography.

Regular/traditional images may use common aspect ratios in which size of one dimension (length) is comparable to the size of another dimension (height), such as 1:1, 4:3, 3:2, 16:9. Image logs, on the other hand, may have aspect ratios in which size of one dimension is not comparable to the size of another dimensions. For example, an image log may have an aspect ratio of 1:1000, or greater. Such difference between the dimensions of image logs from regular/traditional images may prevent use of computer vision tools developed for regular/traditional images from being employed to analyze image logs.

The image log may be divided into multiple image log segments to enable use of computer vision tools developed for regular/traditional images in analyzing the image log. Rather than providing the entirety of the image log to such computer vision tools, individual image log segments may be provided to allow the computer vision tools to analyze the image log in segments. The analysis of the image log in segments may be combined to perform analysis of the image log. For example, prediction of subsurface features (e.g., classification, localization) may be made using multiple image log segments and the predictions may be reconstituted to perform prediction over the entire image log. In some implementations, the image log may be divided into multiple image log in a way so that individual image log segments have an aspect ratio of regular/traditional images (e.g., 1:1, 4:3, 3:2, 16:9). In some implementations, the aspect ratio of the image log segments may be determined based on size of the subsurface features to be analyzed (e.g., classified, localized). For example, the aspect ratio of the image log segments may be controlled so that the image log segments have aspect ratio of regular/traditional images while keeping the size big enough to include the subsurface features to be analyzed. Division of image log into image log segments that have other aspect ratios are contemplated.

In some implementations, one or more channels of an image log may be manipulated for analysis. For example, an image log may provide information as a greyscale image. Computer vision tools developed for regular/traditional images may expect images to be in color. The pixel value of the image log in greyscale may be duplicated into multiple color channels (e.g., into R channel, G channel, and B channel) to make the tools process the image log/image log segments as “color” images.

In some implementations, depths corresponding to individual image log segments may be tracked using one or more database. For example, the starting depth, the ending depth, and/or the range of depth covered by individual image log segments may be tracked in a database. In some implementations, depths corresponding to individual image log segments may be tracked using file name and/or file metadata. For example, the starting depth, the ending depth, and/or the range of depth covered by individual image log segments may be inserted into the file names of the image log segments and/or metadata of the image log segments. In some implementations, depth of different portions of the image log segments may be determined based on the tracked depth and the resolution of the image log segments. For example, the depth range covered by an image log segment and the vertical resolution of the image log segment may be used to determine the depth covered by initial pixels along the vertical direction.

The analysis component 106 may be configured to characterize the subsurface region. Characterizing the subsurface region may include determining/generating information that characterizes the subsurface region and/or determining/generating information from which characteristics of the subsurface region may be determined. Characterizing the subsurface region may include determining characteristics of the subsurface region, such as determining characteristics of subsurface features within the subsurface region and/or determining characteristics of the subsurface region that may be used to identify, classify, and/or locate subsurface features within the subsurface region.

For example, characterization of the subsurface region may include identification of one or more subsurface features within the subsurface region (e.g., identifying that subsurface feature(s) exist within the subsurface region, classifying the subsurface feature(s) within the subsurface region). Characterization of the subsurface region may include determination of probability of the subsurface feature(s) identified within the subsurface region (e.g., probability that the subsurface feature(s) exist within the subsurface region, probability that the surface feature(s) are of certain type/class). Characterization of the subsurface region may include determination of location of the subsurface feature(s) identified within the subsurface region (e.g., where the subsurface feature(s) are located within the subsurface region/image log, geometry of the subsurface feature(s) within the subsurface region/image log, bounding box that includes the subsurface feature(s) within the subsurface region/image log). For example, the analysis component 106 may characterize the subsurface region by outputting a view of the image log/image log segments that includes (1) a bounding box around a subsurface feature, (2) identifies the type of the subsurface feature, and (3) provides a probability score (e.g., percentage) that the identification of the subsurface feature is correct. Other characterization of the subsurface region is contemplated.

In some implementations, characterization of the subsurface region may include identification and/or localization of subsurface feature(s) that have been identified above a confidence threshold. For example, analysis may result in identification of subsurface features with different probabilities of accuracy, and those identification with probabilities of accuracy above an accuracy threshold may be used to characterize the subsurface region. The identification of subsurface features with probabilities of accuracy below the accuracy threshold may not be used to characterize the subsurface region.

In some implementations, the subsurface feature(s) identified within the subsurface region may include one or more sinusoidal subsurface features. A sinusoidal subsurface feature may refer to a subsurface feature that has a sinusoidal shape. For example, the subsurface feature(s) identified within the subsurface region may include fractures that have sinusoidal shape. The fractures may be classified (e.g., type of fracture identified) based on the quality and/or extent of the sinusoidal shape of the fractures.

In some implementations, localization of the subsurface features may include determination of geometric parameter values for the subsurface features. For example, the characterization of the subsurface region may include identification of dip, azimuth, and/or other geometric parameters of the sinusoidal subsurface feature(s). For instance, for a fracture identified within the subsurface region, dip and/or azimuth of the fracture may be determined. Identification of other types of subsurface features and other characteristics of subsurface features are contemplated.

The subsurface region may be characterized based on analysis of the multiple image log segments and/or other information. Analysis of the multiple image log segments may include examining, evaluating, processing, studying, classifying, and/or other analysis of the multiple image log segments. Analysis of the multiple image log segments may include processing the multiple image log segments using one or more computer vision tools, such as computer vision tools developed for regular/traditional images. For example, the multiple image log segments may be analyzed by inputting the multiple image log segments through one or more neural networks and/or other machine learning models. The neural network(s) may include convolutional neural network(s). For example, a general convolutional neural network architecture and/or one or more specific convolutional neural network architectures (e.g., Faster Region-Based Convolutional-Neural-Network, YOLO, etc.) may be used. Use of other neural network(s) are contemplated.

Training of the neural networks to analyze subsurface regions may be onerous. Training may require significant amount of training data as well as processing resource. Rather than training the neural networks strictly with subsurface data, the neural network may be trained initially using training data from a non-subsurface image library. For example, weights for the neural networks may be pretrained by using a common image library, such as ImageNet or COCO. The weights for the neural network may be fine-tuned/updated using subsurface training data. Such re-training of the neural network may enable the neural network to accurately analyze subsurface region without extensive subsurface training data.

In some implementations, the neural networks may be trained (e.g., fine-turned/updated) using subsurface training data that includes identified subsurface features within image logs/image log segments. For example, the neural networks may be trained using examples of fractures and stratigraphic features identified in image logs/image log segments. When passing the image logs/image log segments into the neural networks for training, labels for the image logs/image log segments (e.g., the information on types and/or locations of subsurface features present within the image logs/image log segments) may also be provided. Labels may include types and/or locations of subsurface features within the image logs/image log segments. For example, types of subsurface features within the image logs/image log segments may include drilling induced fracture, resistive fracture, conductive fracture, continuous fracture, semi-continuous fracture, stratigraphic labels (bedding, bedding plane, trough-cross bedding), and/or other subsurface features. Locations of subsurface features within the image logs/image log segments may include depth, azimuth, dip and/or other aspects that define locations of the subsurface features in the subsurface region. Locations of the subsurface features within the image logs/image log segments may include information on geometry of the wellbore to enable reconstruction of the subsurface features. In some implementations, locations of the subsurface features may be converted from the geologic domain (e.g., dip, azimuth) into bounding boxes for use by the neural networks. In some implementations, types and/or locations of the subsurface features within the image logs/image log segments may be tracked using file name and/or file metadata.

In some implementations, one or more data augmentation may be performed on the training data. Normal data augmentation for natural images, such as changing the orientation of the images, inverting color of the image, or cropping the images, may not be appropriate for augmenting image logs. To perform data augmentation for subsurface training data, image logs/image log segments may be translated, image logs/image log segments may be vertically flipped, and/or image log/image log segment intensity may be rescaled. Translating the image logs/image log segments may include shifting the pixels of the image laterally. Pixels of the image that are moved off the image on one side may be added to the image on the other side (e.g., pixels that are moved off the left edge of the image are added to the right side of the image). Translation may effectuate phase shift in the image logs/image log segments (e.g., present images at different azimuth). Vertically flipping the image logs/image log segments may generate images at different dips. Scaling the intensity of the image logs/image log segments may make subsurface features more/less prominent.

In some implementations, the analysis of the multiple image log segments for the characterization of the subsurface region may include use of multiple neural networks. For example, the multiple image log segments may be processed through a base neural network (e.g., Deep CNN). Based on receiving the multiple image log segments as input, the base neural network may provide feature maps for the multiple image log segments. For example, the base neural network may provide tensor of significant features extracted from the multiple image log segments. The feature maps for the multiple image log segments may be processed through a region proposal network. The region proposal network may ingest the feature maps and provide information on the type and/or location of the identified subsurface features.

The region proposal network may perform one or more classification tasks, one or more regression tasks, and/or other tasks. A classification task may include identification of the subsurface feature(s) within the subsurface region and the determination of the probability of the subsurface feature(s) identified within the subsurface region. A classification task performed by the region proposal network may include identification of the type of subsurface feature(s), along with the probability of the classification is accurate (probability of classification accuracy). A regression task may include determination of the location of the subsurface feature(s) identified within the subsurface region. A regression task performed by the region proposal network may include determination of the coordinate(s) of the subsurface feature(s), determination of bounding box(es) that include the subsurface feature(s), and/or determination of dip and azimuth of the subsurface feature(s).

In some implementations, determination of dip and azimuth of the subsurface feature(s) may be performed by the region proposal network as part of its regression task. For example, in addition to determining pixel location of bounding box(es) for detected subsurface feature(s), the region proposal network may be given an additional regression task of solving for the dip and azimuth of the subsurface feature(s).

In some implementations, determination of dip and azimuth of the subsurface feature(s) may be performed as part of post processing. For example, the outputs of the regression and classification by the region proposal network may be passed to one or more post-processing steps that utilize the information output by the region proposal network to calculate the dip and azimuth of the subsurface feature(s).

In some implementations, information on location of the subsurface features may be provided in terms of pixels location within the image log/image log segments. Information on the location of the subsurface features may be converted into depth values. For example, information on coordinates of the bounding box that includes a subsurface feature and/or information on dip and/or azimuth of the subsurface feature may initially be provided in terms of pixel locations. These pixel locations may be converted into depth values based on depth covered by the image (e.g., image log, image log segment) and the position of the pixel within the image. In some implementation, information on the orientation of the image (e.g., with respect to geographic north) may be saved before the image is processed through the neural network. This information (which may be lost during processing through the neural network) may be retrieved after output is obtained from the neural network and used to reorient the results. The results may be reoriented so that the location(s) of the subsurface feature(s) are properly/accurately oriented within the subsurface region.

For example, neural network outputs that manage feature localization may be delivered in pixel locations. Location parameters that describe the features in dip and azimuth may be determined using a custom loss function that adds those features which are continuous values (i.e., dip and azimuth) as regression targets. Conversion of features to depth may utilize prior knowledge of the depth range spanned by the image log.

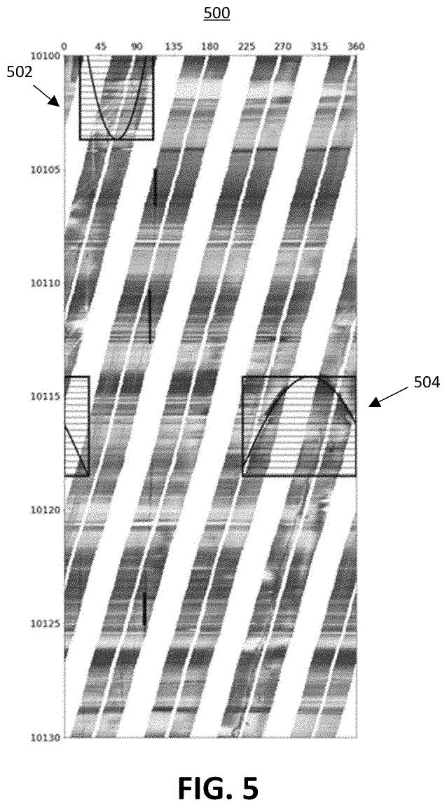

FIG. 5 illustrates example identification of sinusoidal features 502, 504 within an image log 500. The image log 500 may be divided into multiple image log segments (such as shown in FIGS. 4A and 4B). The multiple image log segments may be processed through a base neural network and a region proposal network to both classify and determine locations of the sinusoidal features 502, 504. That is, by processing the multiple image log segments through the base neural network and the region proposal network, the types of the sinusoidal features 502, 504, as well as the locations of the sinusoidal features 502, 504 (e.g., bounding boxes that include the sinusoidal features 502, 504) may be determined.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

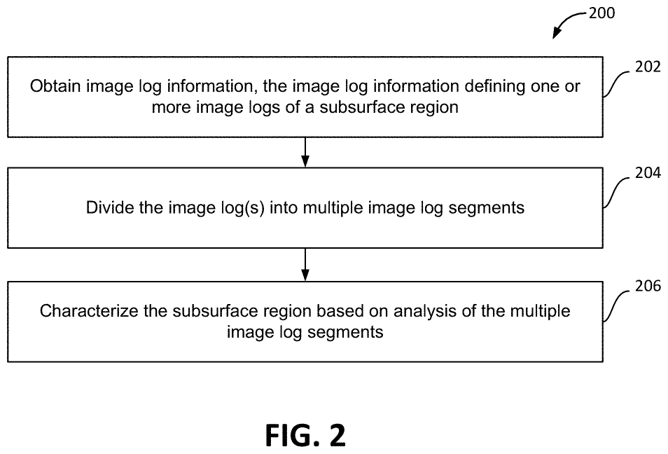

FIG. 2 illustrates method 200 for characterizing subsurface regions. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, image log information and/or other information may be obtained. The image log information may define one or more image logs of a subsurface region. In some implementation, operation 202 may be performed by a processor component the same as or similar to the image log component 102 (Shown in FIG. 1 and described herein).

At operation 204, the image log(s) may be divided into multiple image log segments. In some implementation, operation 204 may be performed by a processor component the same as or similar to the preparation component 104 (Shown in FIG. 1 and described herein).

At operation 206, the subsurface region may be characterized based on analysis of the multiple image log segments and/or other information. Characterization of the subsurface region may include identification of one or more subsurface features within the subsurface region, determination of probability of the subsurface feature(s) identified within the subsurface region, determination of location of the subsurface feature(s) identified within the subsurface region, and/or other characterization of the subsurface region. In some implementation, operation 206 may be performed by a processor component the same as or similar to the analysis component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for characterizing subsurface regions, the system comprising:
one or more physical processors configured by machine-readable instructions to:
obtain image log information, the image log information defining an image log of a subsurface region;
divide the image log into multiple image log segments; and
characterize the subsurface region based on analysis of the multiple image log segments, wherein characterization of the subsurface region includes identification of one or more subsurface features within the subsurface region, determination of probability of the one or more subsurface features identified within the subsurface region, and determination of location of the one or more subsurface features identified within the subsurface region.

2. The system of claim 1, wherein the analysis of the multiple image log segments for the characterization of the subsurface region includes:
processing the multiple image log segments through a base neural network, the base neural network providing feature maps for the multiple image log segments; and
processing the feature maps for the multiple image log segments through a region proposal network.

3. The system of claim 2, wherein the region proposal network performs a classification task and a regression task.

4. The system of claim 3, wherein the classification task includes the identification of the one or more subsurface features within the subsurface region and the determination of the probability of the one or more subsurface features identified within the subsurface region.

5. The system of claim 4, wherein the regression task includes the determination of the location of the one or more subsurface features identified within the subsurface region.

6. The system of claim 1, wherein the one or more subsurface features identified within the subsurface region includes a sinusoidal subsurface feature.

7. The system of claim 6, wherein the characterization of the subsurface region further includes identification of dip and azimuth of the sinusoidal subsurface feature.

8. The system of claim 1, wherein the image log is divided into the multiple image log segments such that adjacent image log segments have an overlapping area.

9. The system of claim 1, wherein the image log is divided into the multiple image log segments such that adjacent image log segments do not have an overlapping area.

10. The system of claim 1, wherein the image log includes one or more gaps, and the one or more gaps are removed from the image log before the division of the image log into the multiple image log segments.

11. A method for characterizing subsurface regions, the method comprising:
obtaining image log information, the image log information defining an image log of a subsurface region;
dividing the image log into multiple image log segments; and
characterizing the subsurface region based on analysis of the multiple image log segments, wherein characterization of the subsurface region includes identification of one or more subsurface features within the subsurface region, determination of probability of the one or more subsurface features identified within the subsurface region, and determination of location of the one or more subsurface features identified within the subsurface region.

12. The method of claim 11, wherein the analysis of the multiple image log segments for the characterization of the subsurface region includes:
processing the multiple image log segments through a base neural network, the base neural network providing feature maps for the multiple image log segments; and
processing the feature maps for the multiple image log segments through a region proposal network.

13. The method of claim 12, wherein the region proposal network performs a classification task and a regression task.

14. The method of claim 13, wherein the classification task includes the identification of the one or more subsurface features within the subsurface region and the determination of the probability of the one or more subsurface features identified within the subsurface region.

15. The method of claim 14, wherein the regression task includes the identification of the location of the one or more subsurface features identified within the subsurface region.

16. The method of claim 11, wherein the one or more subsurface features identified within the subsurface region includes a sinusoidal subsurface feature.

17. The method of claim 16, wherein the characterization of the subsurface region further includes identification of dip and azimuth of the sinusoidal subsurface feature.

18. The method of claim 11, wherein the image log is divided into the multiple image log segments such that adjacent image log segments have an overlapping area.

19. The method of claim 11, wherein the image log is divided into the multiple image log segments such that adjacent image log segments do not have an overlapping area.

20. The method of claim 11, wherein the image log includes one or more gaps, and the one or more gaps are removed from the image log before the division of the image log into the multiple image log segments.
